(19) United States
(12) Patent Application Publication
(10) Pub. No.: US 2009/0126024 A1
(43) Pub. Date: May 14, 2009

(54) METHOD AND SYSTEM FOR MANAGING SOFTWARE LICENSES AND STORAGE APPARATUS

(75) Inventor: Toshihiko HIMENO, Tokyo (JP)

Correspondence Address: BANNER & WITCOFF, LTD.;ATTORNEYS FOR CLIENT NO. 000449, 001701, 1100 13th STREET, N.W., SUITE 1200, WASHINGTON, DC, 20005-4051, US

(73) Assignee: KABUSHIKI KAISHA TOSHIBA, Tokyo (JP)

(21) Appl. No.: 12/348,416

(22) Filed: Jan. 5, 2009

Related U.S. Application Data
(62) Division of application No. 10/101,632, filed on Mar. 21, 2002.

(30) Foreign Application Priority Data
Mar. 21, 2001 (JP) 2001-080677
Mar. 18, 2002 (JP) 2002-074914

(51) Int. Cl. G06F 21/00

(52) U.S. Cl. 726/26

(57) ABSTRACT

The management of software licenses becomes easy without incurring an increase in costs to effectively prevent software applications from unauthorized use. The software license managing method including: judging, when a software program installed in a computer is executed, whether or not a memory card having a predetermined ID is connected to said computer by an ID extracting and verifying program; permitting execution of said software program if the ID extracting and verifying program judges that said memory card is connected to said computer; inhibiting execution of said software program if the ID extracting and verifying program judges that said memory card is not connected to said computer.

### CROSS REFERENCE TO RELATED APPLICATIONS

This application is a divisional of U.S. application Ser. No. 10/101,632 filed Mar. 21, 2002, which is based upon and claims the benefit of priority from prior Japanese Patent Application 2001-80677 filed on Mar. 21, 2001 and Japanese Patent Application 2002-74914 filed on Mar. 18, 2002, the entire contents of these applications are incorporated by reference herein.

### BACKGROUND

1. Field of the Invention

The present invention relates to a software license managing method of preventing software applications from unauthorized use by the use of a memory card. Particularly, the present invention relates to a software license managing system suitable for personal computers which can not be distinguished from each other.

2. Description of the Related Art

Software for small computers such as PCs is released, for example, in the form of packaged products with CD-ROMs. License copies to a software application is managed by a printed paper in which is written the license number as given to a user together with a CD-ROM storing the software application. In accordance with this practice, when a software application is installed, the user has to input the license number as given together with the CD-ROM. If the license number as input to the system is correct, it is confirmed that the user is licensed to run the program.

In this case, however, the user given a license number can install the same software application in any other PC. Also, any person who is not authorized but get a license number can install the same software application without the license. This practice results in the temptation to do software piracy. Accordingly, it is apparently problematic from the standpoint of preventing unauthorized use to confirm the license only by the license number and therefore some practical measure is needed.

On the other hand, there are some relative expensive software applications in which anti-piracy measure is implemented by means of hardware. For example, such a software application can start up only when a predetermined signal can be read from a serial port or a printer port of a PC to which is connected an adapter which is provided together with the software application in order to confirm the software application is licensed. In accordance with this practice, an adaptor(s) corresponding to the number of the license copies is given to the user together with a medium in which is stored a software application. The user connects the adaptor to each of the PC(s) corresponding to the number of the license copies so that it is impossible to use the software application at a time in a PC other than the PC(s) corresponding to the number of the license copies. In this case, the software application can be used in the number of PCs corresponding to the number of the license copies, while the software application can be installed in a larger number of PCs irrespective of the number of the license copies as granted, so that this license condition is particularly convenient in the case where many persons use the software application only at times.

However, in the case of this license condition as described above by the use of an adaptor, the configuration of the adaptor is not complicated and can be replicated with little cost or effort.

Alternatively, an IC can be embedded in the adaptor in order to exclude such replication. However, this raises the cost so that this is not the practice except for some expensive software applications. On the other hand, if the hardware for protecting software from unauthorized copies is standardized, it becomes difficult to control the security of the hardware. The respective software developers have to develop a proprietary technique to protect software from unauthorized copies at an additional cost. Furthermore, when the adaptor as an anti-piracy measure is connected to a serial port or a printer port of a PC, there is an inconvenience for the user while the serial port or the printer port can not be used for another purpose.

As explained above, in the license managing system as described above, in the case where a software application is purchased with a license number, there are shortcomings that an unauthorized copy can be easily created with the license number. On the other hand, in the case where a software application is purchased with a particular hardware device against piracy, there are shortcomings that such a hardware device can be easily replicated, that the provision of such a hardware device raises the cost and that the usability of a PC is deteriorated.

### BRIEF SUMMARY

An aspect of the present invention provides a software license managing method comprising: judging, when a software program installed in a computer is executed, whether or not a memory card having a predetermined ID is connected to said computer by an ID extracting and verifying program; permitting execution of said software program if the ID extracting and verifying program judges that said memory card is connected to said computer; inhibiting execution of said software program if the ID extracting and verifying program judges that said memory card is not connected to said computer.

Another aspect of the present invention provides a software license managing method comprising: judging, when a software program is installed in a computer, whether or not a memory card having a predetermined ID is connected to said computer by an ID extracting and verifying program; permitting installation of said software program if the ID extracting and verifying program judges that said memory card is connected to said computer; inhibiting installation of said software program if the ID extracting and verifying program judges that said memory card is not connected to said computer.

A further aspect of the present invention provides a software license managing system configured to manage licenses of a software application given to users from a software manufacturer, comprising: a first storage device in which is embedded a first ID which is assigned to said first storage device, said first ID being non-rewritable; a second storage device in which are stored the software application, a ID extracting and verifying program and a second ID corresponding to said first ID; a user computer with which said first ID is read out from said first storage device while said software application, said ID extracting and verifying program and said second ID are read out from said second storage device; wherein, when said software program stored in said second storage device is installed and/or executed, said ID extracting and verifying program as read out from said second storage device compares said first ID as read out from said first storage device with said second ID as read out from said second storage device, and installation and/or execution is permitted only when there is a match between said first ID and said second ID.

A still further aspect of the present invention provides a storage apparatus for use in a software license managing system configured to manage licenses of a software application given to users from a software manufacturer, said storage apparatus comprising: a first storage device in which is embedded a first ID which is assigned to said first storage device, said first ID being non-rewritable; and a second storage device in which is stored the software application, a ID extracting and verifying program and a second ID corresponding to said first ID; wherein, when said software program stored in said second storage device is installed and/or executed, said ID extracting and verifying program as read out from said second storage device compares said first ID as read out from said first storage device with said second ID as read out from said second storage device, and installation and/or execution is permitted only when there is a match there is a match between said first ID and said second ID.

### BRIEF DESCRIPTION OF THE DRAWINGS

FIG. 1A is a general overview of a software license managing system in accordance with a first embodiment of the present invention. FIG. 1B is a schematic block diagram showing the major portions of the PC for use in the software license managing system as illustrated in FIG. 1A.

FIG. 2 is a flowchart showing the procedure for checking a software license in the software license managing system as illustrated in FIG. 1.

FIG. 3 is a general overview of a software license managing system in accordance with a second embodiment of the present invention.

FIG. 4 is a flowchart showing the procedure for checking a software license by the software license managing system as illustrated in FIG. 3.

### DETAILED DESCRIPTION OF THE INVENTION

In the followings, various embodiments of the present invention will be described with reference to the accompanying drawings.

The present invention relates to a software license managing method and a software license managing system of preventing software applications from unauthorized use by making use of the ID embedded in a memory card as the license management information for the purpose of managing the use of a software application for personal computers (PCs) which can not be distinguished from each other. In recent years, there are increased such types of memory cards having an ID which can be used for distinguishing the respective products from each other in order to meet the necessity for online distribution of information such as data in the form of MP3 which is a type of compression. The ID is used for managing software licenses of software applications for PCs. A unique IDs is embedded in each of the respective products of a memory card and can not be rewritten. In some cases, the IDs of only particular products can be rewritten in a limited condition.

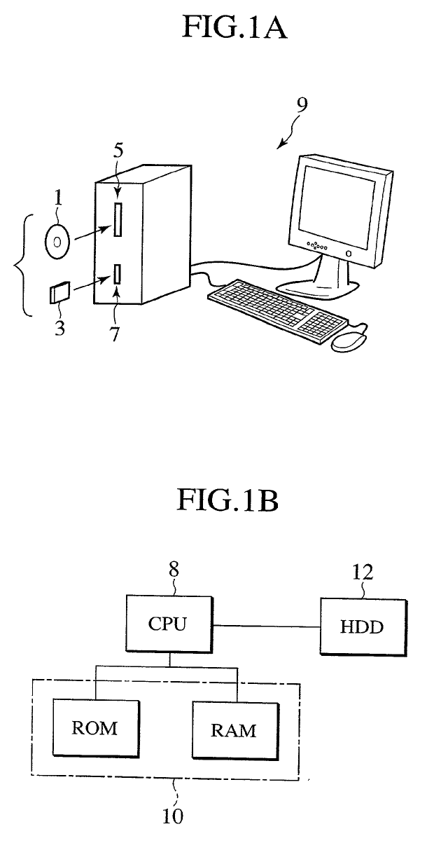

Next, the software license managing system in accordance with a first embodiment of the present invention will be explained with reference to FIG. 1 to FIG. 4.

FIG. 1A is a general overview of the software license managing system as described above. FIG. 1B is a schematic block diagram showing the major portions of the PC for use in the software license managing system as described above.

As illustrated in FIG. 1A, the software license managing system is composed of a computer-readable medium (a large capacity storage media, i.e., a CD-ROM in this case) 1 in which is stored a software program, as well as an ID extracting and verifying program, which is purchased by a user from a software manufacturer, a memory card 3 enclosed with the CD-ROM 1, a first reading unit 5 for reading data from the CD-ROM 1 and a second reading unit 7 for reading data from the memory card 3 as described above. This software license managing system is implemented in a PC 9 used by the user.

Also, the PC 9 as described above includes a CPU 8, a memory (RAM and ROM) 10 and a hard disk drive 12 as illustrated in FIG. 1B.

Meanwhile, in this example, the software program and the ID extracting and verifying program are stored in the CD-ROM 1 which is provided separate from the memory card 3. However, it is possible to store the software program and the ID extracting and verifying program together in the memory card 3 and to distribute the memory card 3 alone as a software program product. In this case, however, the first reading unit 5 may be dispensed with in the PC 9.

Meanwhile, written in the CD-ROM 1 as described above is the same ID as written in the memory card 3 as described above for the purpose of checking a match. Namely, the ID is embedded in the memory card as license information.

Next, the operation (the method of the use) of the software license managing system as illustrated in FIG. 1A will be explained.

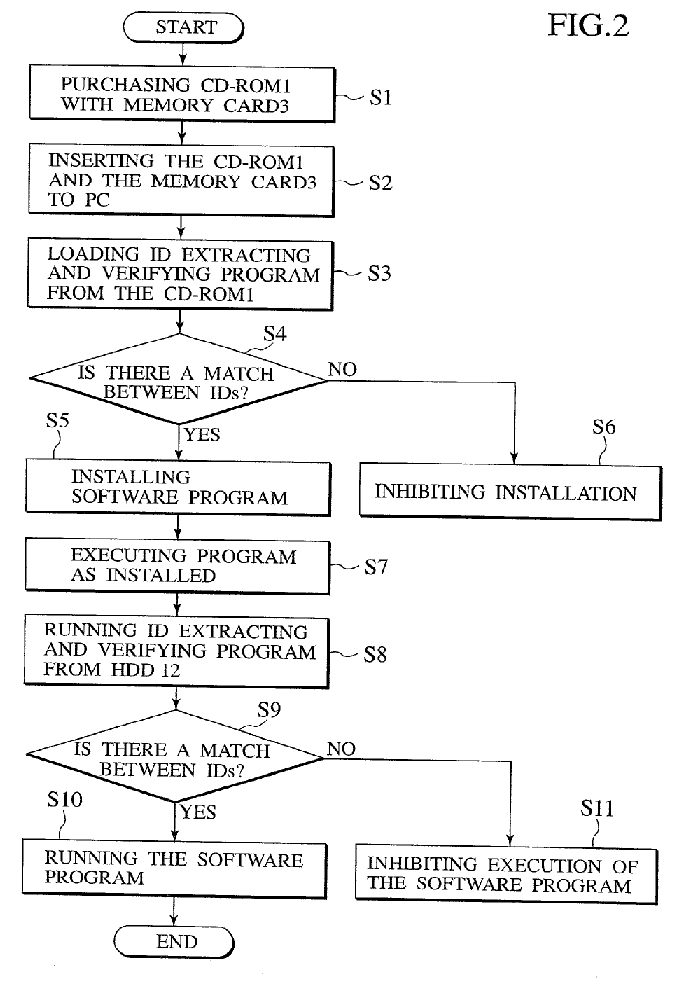

FIG. 2 is a flowchart showing the procedure for checking a software license in the software license managing system as illustrated in FIG. 1.

As illustrated in FIG. 2, the user purchases a package of the software program including the CD-ROM 1 storing the software program he desired and the memory card 3 bundled therewith in the step S1. The CD-ROM 1 and the memory card 3 are inserted respectively to the first and second reading units 5 and 7 of the PC 9 as described above in the step S2 in order to access thereto.

After inserting the CD-ROM 1 and the memory card 3 as described above, installation of the software program is initiated. However, in advance of actual installation, the ID extracting and verifying program is loaded to the memory 10 from the CD-ROM 1 by the PC 9 in order to read and check the ID (non-rewritable) of the memory card 3 in the step S3. Next, in the step S4, the ID of the memory card 3 is extracted from the memory card 3 by the ID extracting and verifying program and compared with the ID of the memory card 3 as stored in the CD-ROM 1 (included in the ID extracting and verifying program in this case). Meanwhile, the ID extracting and verifying program as described above is used also when the software program is actually executed for use and therefore stored in a hard disk drive 12 of the PC 9.

If the ID of the memory card 3 as extracted from the memory card 3 is identical to the ID of the memory card 3 as stored in the CD-ROM 1 in the step S4, the software program stored in the CD-ROM 1 is installed in the hard disk drive 12 of the PC 9 in the step S5. If not identical, the installation of the software program is inhibited in the step S6.

Next, when the user runs the software program as installed in the step S7, the ID extracting and verifying program is loaded from the hard disk drive 12 to the memory 10 in the step S8, and serves to read the ID of the memory card 3 from the memory card 3 and compare it with the ID of the memory card 3 included in the ID extracting and verifying program in advance in the step S9.

If the ID of the memory card 3 as extracted from the memory card 3 is identical to the ID of the memory card 3 included in the ID extracting and verifying program in the step S9, the software program as installed in the hard disk drive 12 is loaded to the memory and executed in the step S10. If not identical, the execution of the software program is inhibited in the step S11.

In the case of the above described embodiment, it is possible to dispense with the verification process of ID during the installation of the software program, i.e., the step S3, S4 and S6, in order to transfer the control directly from the step S2 to the step S5.

Meanwhile, in the case of the above described embodiment, the memory card 3 is inserted to the second reading unit 7 provided for this purpose. However, it is possible to insert the memory card 3 to a legacy interface such as a PCM-CIA slot and the like through an appropriate adaptor or to connect the memory card 3 to a USB port and the like by the use of a card reader.

In this manner, in accordance with the above described embodiment, the ID of the memory card 3 as extracted from the memory card 3 is compared to the ID of the memory card 3 as stored in the CD-ROM 1 in advance, and the use of the program is permitted only when the ID of the memory card 3 as extracted from the memory card 3 is identical to the ID of the memory card 3 as stored in the CD-ROM 1. In accordance with the software license managing system as described above, it is possible to prevent a software application from piracy while the user can install and execute the software program in the same manner as in accordance with the conventional practice without awareness of the ID of the memory card 3.

Accordingly, in the case of the above described embodiment, a software manufacturer need not develop a proprietary technique to protect software but can use the function of an existing memory card for the purpose of managing the software licenses. Some means for reading the memory card is inevitable in this case. However, there are standardized interfaces such as PCM-CIA and in the case of most existing PCs there is no inconvenience. As a result, it is possible to prevent software applications from unauthorized use without incurring substantial costs.

Meanwhile, the memory card 3 as described above serves to store several information such as financial information, medical information and so forth relating to the user.

Next, the second embodiment of the present invention will be explained.

In the case of the second embodiment of the present invention, the ID of a memory card is used for a software program which is distributed online through the Internet and the like network rather than distributed with a computer-readable medium (CDROM).

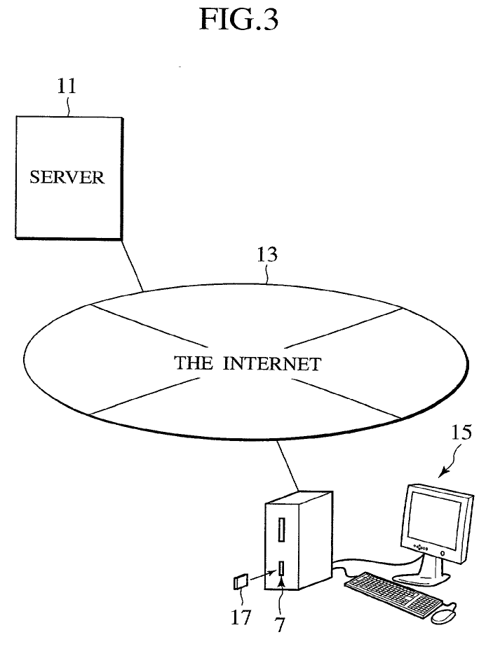

FIG. 3 is a general overview of the software license managing system in accordance with the second embodiment of the present invention.

As illustrated in FIG. 3, the software license managing system is established with a server 11 of a software manufacturer connected to the communication network 13 such as the Internet for distributing software and a personal computer (PC) 9 of a user which is connected to the communication network 13. The PC 15 is provided with a second reading unit 7 for accessing a memory card 17 which is inserted thereto. The PC 15 is also equipped with a CPU 8, a memory (RAM and ROM) 10 and a hard disk drive 12 as illustrated in FIG. 1B.

An ID is embedded in the memory card 17 in the same manner as in the first embodiment. In this case, however, the ID has been uniquely determined in correspondence with the software program which can be used with the memory card 17.

Next, the operation (the method of the use) of the software license managing system in accordance with the second embodiment of the present invention as illustrated in FIG. 3 will be explained.

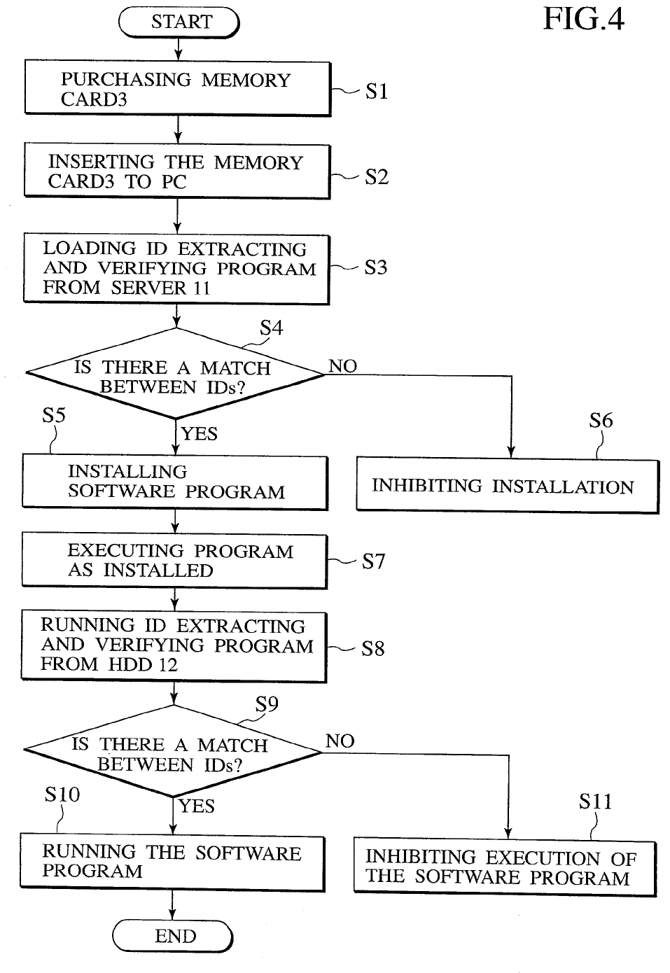

FIG. 4 is a flowchart showing the procedure for checking a software license by the software license managing system as illustrated in FIG. 3.

As illustrated in FIG. 4, the user purchases the memory card 17 which is necessary when the software program as desired is downloaded from the server of the software manufacturer in the step S1. Namely, the price of the memory card 17 includes the payment for the software program. Next, in the step S2, the memory card 17 is inserted to the reading unit 7 of the PC 15 as described above.

Next, the user accesses to the server 11 of the software manufacturer to download the software program through a homepage and the like. However, in advance of actually downloading the software program, an ID extracting and verifying program is downloaded and installed for reading and checking the ID of the memory card 3 in the step S3. Next, in the step S4, the ID extracting and verifying program accesses to the memory card 17 and extracts the ID thereof to match the ID corresponding to the software program (included in the ID extracting and verifying program). Meanwhile, the ID extracting and verifying program is saved in the hard disk drive 12 of the PC 15.

If the ID of the memory card 3 as extracted from the memory card 3 is identical to the ID of the software program included the ID extracting and verifying program in the step S4, the software program is downloaded to and installed in the hard disk drive 12 of the PC 15 in the step S5. Alternatively, the software program may be downloaded to the hard disk drive 12 together with the ID extracting and verifying program so that only the installation is performed in the step S5.

Also, in the step S4 as described above, the ID of the memory card 3 as extracted from the memory card 3 is not identical to the ID of the software program included the ID extracting and verifying program in the step S4, the download and the installation of the software program (or only the installation) is inhibited in the step S6.

Next, when the user runs the software program as installed in the step S7, the ID extracting and verifying program is loaded from the hard disk drive 12 to the memory 10 in the step S8, and serves to read the ID of the memory card 3 from the memory card 3 and compare it with the ID of the software program included in the ID extracting and verifying program in advance in the step S9.

If the ID of the memory card 3 as extracted from the memory card 3 is identical to the ID of the software program included the ID extracting and verifying program in the step S9, the software program is loaded and executed in the step S10. If not identical, the execution of the software program is inhibited in the step S11.

In the case of the above described embodiment, it is possible to dispense with the verification process of ID during the installation of the software program, i.e., the step S3, S4 and S6, in order to transfer the control directly from the step S2 to the step S5.

Meanwhile, an ID is uniquely defined corresponding to a software program in the case of the second embodiment of the present invention. In other words, the number of copies of the memory card 17 having the same ID are corresponding to the same software program so that the corresponding number of copies of the same software program may be installed in PCs of users each having a copy of the memory card. However, while the respective individual products of the memory card have different product IDs with which different products of the same memory card are distinguished from each other, a group of product IDs of the memory card can be defined to be associated with the same software program so that a license is confirmed when the memory card 17 has an ID which is equal to any one of the IDs belonging to the group.

Furthermore, the anti-piracy mechanism can be enhanced by implementing the memory cards 3 and 17 with the function of restricting the number of read cycles.

Meanwhile, while the purchase of software programs has been described in the case of the embodiments as described above, the present invention is also applicable to the purchase of music software and other types of data.

Also, in the case of such a software application as often requires version-up, only memory cards are distributed to the users while a latest program is transferred online to each user through the Internet each time a new version is released.

As explained above, since software licenses are managed by the use of the ID of a memory card in accordance with the present invention, the management of software licenses becomes easy without incurring an increase in costs to effectively prevent software applications from unauthorized use.

Meanwhile, the ID extracting and verifying program (or the CD-ROM) is generally implemented with, for example, a table of valid IDs for verifying the ID of a memory card in the case of the embodiments as described above.

However, depending on the actual design of the system, the valid IDs are defined by a range of IDs which are treated as valid during verification. In this case, for example, MAXID=10000 is defined as a maximum value so that the ID of a memory card is recognized as valid only when it is no larger than 10000. Also, MINID=90000 is defined as a minimum value so that the ID of a memory card is recognized as valid only when it is no smaller than 90000. Also, MINID=110000 is defined as a maximum value and MINID=100000 is defined as a minimum value so that the ID of a memory card is recognized as valid only when it is equal thereto or located therebetween.

The foregoing description of the embodiments has been presented for purposes of illustration and description. It is not intended to be exhaustive or to limit the invention to the precise form described, and obviously many modifications and variations are possible in light of the above teaching. The embodiment was chosen in order to explain most clearly the principles of the invention and its practical application thereby to enable others in the art to utilize most effectively the invention in various embodiments and with various modifications as are suited to the particular use contemplated.

For example, when the user wants to purchase an additional number of license copies for the same software program at least one copy has been already purchased, only copies of the memory card 3 without the CD-ROM are purchased in order to increase the number of PCs in which the software program can be running at the same time. In this case, the ID(s) of a memory card(s) purchased anew together with a license of the software program is registered by the software program as an effective ID.

Also, while the ID of the memory card 3 is verified only when the software program is installed and/or only when the software program is executed in the case of the embodiments as described above, it is effective to irregularly or regularly access to the memory card 3 at times while the software program is running to verify the ID of the memory card in order to confirm whether or not the software program is running after removing the memory card 3.

What is claimed is:

1. A license management method comprising:
sending an identifier of a first memory device to a connected first computing device in response to the first computing device receiving a request to execute a first command corresponding to a software program, wherein after determining that the identifier of the first memory device matches an identifier stored in a second memory device, the first computing device executes the first command; and
sending an identifier of a first memory device to a connected second computing device in response to the second computing device receiving a request to execute a second command corresponding to the software program, wherein after determining that the identifier of the first memory device matches an identifier stored in the second memory device, the second computing device executes the requested command,
wherein the first memory device is selectively connectable to one of the first computing device and the second computing device.

2. The method of claim 1, wherein the first memory device is, at most, connected to one of the first computing device and the second computing device at any time.

3. The method of claim 2, wherein the second memory device is read by the first and second computing device to determine the identifier.

4. The method of claim 2, wherein the first command and the second command corresponding to the software program is to install the software program at the first and second computing devices, respectively.

5. The method of claim 2, wherein the first command and the second command corresponding to the software program is to execute the software program at the first and second computing devices, respectively, wherein the software program is already installed at the first and second computing devices.

6. The method of claim 2, wherein the identifier of the first memory device is sent to the first and second computing device, respectively, via a universal serial bus connection.

7. A first computing device comprising:
an interface configured to connect to a first memory device, wherein the first memory device is selectively connectable to a second computing device such that when connected to the second computing device, and upon verifying that the first memory device comprises a identifier that matches an identifier of a second memory device read by the second computing device, the second computing device executes a command corresponding to a software program, wherein the software program is associated with the identifier of the first memory device and the identifier of a second memory device,
a memory configured to store computer-readable instructions; and
a processor, when executing the computer-readable instructions, the processor configured to
determine that the first memory device is connected to the first computing device,
receive, from the first memory device, an identifier of the first memory device,
execute, at the first computing device, an identifier extraction program, wherein the identifier extraction program determines whether the identifier of the first memory device matches a predetermined identifier, and
perform a command corresponding to a software program at the first computing device in response to the identifier extraction program determining that the identifier of the first memory device matches the predetermined identifier.

8. The first computing device of claim 7, wherein the predetermined identifier is stored at the second memory device, and wherein the identifier extract program is also stored in the second memory device, and wherein the identifier extraction program is executed at the first computing device in response to the first device downloading the identifier extraction program from the second memory device.

9. The first computing device of claim 7, wherein determining whether the identifier of the connected first memory device matches the predetermined identifier comprises comparing the identifier of the connected first memory device with the predetermined identifier stored in the second memory device, wherein the second memory device provides the first computing device with the predetermined identifier.

10. The first computing device of claim 7, wherein the software program is stored in the second memory device, and wherein the command to be performed at the first computing device is installing the software program onto the first computing device.

11. The first computing device of claim 7, wherein the identifier extraction program executed at the first computing device, the predetermined identifier, and the software program corresponding to the command performance at the first computing device are all downloaded by the first computing device from a server.

12. A system comprising:
a first memory device comprising an first memory identifier; and
a second memory device comprising a predetermined identifier, an identifier extraction program, and a software program, wherein the first memory identifier, the predetermined identifier and the identifier extraction program all correspond to the software program,
wherein the first memory device sends the first memory identifier to a first computing device when connected to the first computing device and the second memory device sends the predetermined identifier and the software program to the first computing device when the second memory device is read by the first computing device, such that the first computing device executes a command corresponding to the software program if the first computing device determines that the first memory identifier and the predetermined identifier match, and
wherein the first memory device sends the first memory identifier to a second computing device when connected to the second computing device and the second memory device sends the predetermined identifier and the software program to the second computing device when the second memory device is read by the second computing device, such that the second computing device executes a command corresponding to the software program if the second computing device determines that the first memory identifier and the predetermined identifier match.

13. The system of claim 12, wherein first computing device determines that the first memory identifier and the predetermined identifier match by comparing the first memory identifier received via a universal serial bus drive connected to the first memory device with the predetermined identifier read from the second memory device, wherein the second memory device is a compact disc ROM (CD-ROM) accessible to the first computing device.

14. A license management method comprising:
determining that a first memory device corresponding to a first user is connected to a computing device; wherein the first memory device comprises an identifier of the first memory device;
executing, at the first computing device, an identifier extraction program, wherein the identifier extraction program determines whether the identifier of the connected first memory device matches a predetermined identifier;
performing a first command corresponding to a software program at the computing device in response to the identifier extraction program determining that the identifier of the first memory device matches the predetermined identifier;
determining that a second memory device corresponding to a second user is connected to the computing device; wherein the second memory device comprises an identifier of the second memory device;
executing, at the first computing device, an identifier extraction program, wherein the identifier extraction program determines whether the identifier of the connected second memory device matches a predetermined identifier;
performing a second command corresponding to a software program at the computing device in response to the identifier extraction program determining that the identifier of the second memory device matches the pre-determined identifier.

15. The method of claim 14, wherein the first command corresponding to the software program performed by the computing device, in response to the identifier extraction program determining that the identifier of the first memory device matches the pre-determined identifier, installs the software program on the computing device and wherein the second command corresponding to the software program performed by the computing device, in response to the identifier extraction program determining that the identifier of the second memory device matches the pre-determined identifier, runs the software program on the computing device.

16. The method of claim 14, further comprising:
performing a second command corresponding to the software program at the computing device in response to the identifier extraction program determining that the identifier of the connected first memory device matches the pre-determined identifier, wherein the second command runs the software program on the computing device.

17. A computing device comprising:
an interface configured communicate with a connected one of a first memory device and a second memory device, wherein the first memory device corresponds to a first user and comprises an identifier of the first memory device, and wherein the second memory device corresponds to a second user and comprises an identifier of the second memory device,
a processor, and
a memory storing computer-readable instructions that when executed by the processor, performs the method:
determining that one of the first and second memory device is connected to the first computing device,
executing, at the computing device, an identifier extraction program, wherein the identifier extraction program determines whether the identifier of the connected device matches a predetermined identifier, and
performing a command corresponding to a software program at the computing device in response to the identifier extraction program determining that the identifier of the connected memory device matches the pre-determined identifier.

18. The computing device of claim 17, wherein a third memory device stores the predetermined identifier, the identifier extraction program, and the software program, wherein the computing device downloads the identifier extraction program and the software program from the connected one of the first memory device and the second memory device, and obtains the pre-determined identifier from the third memory device.

19. The computing device of claim 18, wherein the first and second memory devices are configured to be connectable to a universal serial bus drive of the computing device and wherein the third memory device is a compact disc ROM (CD-ROM) readable by the computing device.

20. The computing device of claim 18, wherein the first and second memory devices are configured to be connectable to a universal serial bus drive of the computing device and wherein the third memory device is a server.
